(19) United States
(12) Patent Application Publication
(10) Pub. No.: US 2015/0152975 A1
(43) Pub. Date: Jun. 4, 2015

(54) FAUCET HANDLE ASSEMBLY

(71) Applicant: Delta Faucet Company, Indianapolis, IN (US)

(72) Inventor: Patrick B. Jonte, Zionsville, IN (US)

(21) Appl. No.: 14/618,680

(22) Filed: Feb. 10, 2015

Related U.S. Application Data
(63) Continuation-in-part of application No. 13/739,717, filed on Jan. 11, 2013.
(60) Provisional application No. 61/938,994, filed on Feb. 12, 2014.

(51) Int. Cl. F16K 31/60

(52) U.S. Cl. CPC F16K 31/602

(57) ABSTRACT

A faucet handle assembly includes a handle having a user input portion and a shaft extending axially downwardly from the user input portion. A hub includes a side wall defining an internal chamber extending between an open upper end and an open lower end, the open upper end rotatably receiving the shaft of the handle. A mounting base is received within the internal chamber of the hub and secures the hub to a mounting deck.

### CROSS-REFERENCE TO RELATED APPLICATIONS

This application is a continuation-in-part of U.S. patent application Ser. No. 13/739,717, filed Jan. 11, 2013, and claims priority to U.S. Provisional Patent Application Ser. No. 61/938,994, filed Feb. 12, 2014, the disclosures of which are expressly incorporated herein by reference.

### BACKGROUND AND SUMMARY OF THE DISCLOSURE

The present invention relates to a faucet handle assembly and, more particularly, to a faucet handle assembly that eliminates a conventional set screw for coupling a handle member to a valve stem.

Conventional faucet handle assemblies often utilize an externally visible fastener (e.g., a set screw) to secure a handle member (e.g., a lever or a knob) to a valve stem. The set screw may present an aesthetically unpleasant appearance, often requiring a button or cover to hide the set screw.

According to an illustrative embodiment of the present disclosure, a faucet handle assembly includes a handle having a user input portion and a shaft extending downwardly along a longitudinal axis from the user input portion. The shaft includes a shoulder defining a downwardly facing surface. A hub includes a side wall defining an internal chamber extending between an open upper end and an open lower end. The open upper end includes an upwardly facing surface. A lip within the internal chamber of the hub defines a downwardly facing surface. The shaft of the handle is received within the open upper end of the hub for rotation about the longitudinal axis. Retainer tabs extend inwardly from the side wall into the internal chamber proximate the open lower end. A push nut retains the shaft of the handle to the hub. The push nut includes an upper surface and is slidably adjustable along the shaft of the handle for axial positioning relative to the downwardly facing surface of the lip of the hub for accommodating tolerances between the handle and the hub. The upwardly and downwardly facing surfaces of the hub are captured between the downwardly facing surface of the shaft of the handle and the upper surface of the push nut.

An upper glide ring is positioned intermediate the shaft of the handle and the hub to define an upper bearing between the downwardly facing surface of the shoulder of the handle and the upwardly facing surface of the upper end of the hub. A lower glide ring is positioned intermediate the hub and the push nut to define a lower bearing between the downwardly facing surface of the lip of the hub and the upper surface of the push nut. A mounting base includes a support defining a central opening and arms positioned outwardly from the central opening and defining rotational lock channels to receive the retainer tabs of the hub. The hub is in an unlocked position when the tabs are positioned outside of the channels, and the hub is a locked position when the hub is rotated about the longitudinal axis from the unlocked position such that the tabs are received within the lock channels.

According to another illustrative embodiment of the present disclosure, a faucet handle assembly for coupling to a valve stem includes a handle having a user input portion and a shaft extending downwardly from the user input portion. The shaft includes a shoulder defining a downwardly facing surface. A hub includes a side wall defining an internal chamber extending between an open upper end and an open lower end. The open upper end includes an upwardly facing surface. The shaft of the handle is rotatably received within the open upper end of the hub. A push nut retains the shaft to the hub, and is slidably adjustable along the shaft of the handle for axial positioning relative to the downwardly facing surface of the shoulder of the handle for accommodating tolerances between the handle and the hub. A valve body includes an upper receiving member configured to receive a valve cartridge having a valve stem, and a mounting shank extending downwardly from the upper receiving member. A mounting base defines a central opening, wherein the mounting shank of the valve body extends through the central opening. A valve body orientation device angularly orients the valve body relative to the mounting base. A hub orientation device angularly orients the hub relative to the mounting base. A handle orientation device angularly orients the user input portion of the handle relative to the valve stem.

According to another illustrative embodiment of the present disclosure, a faucet handle assembly includes a handle having a user input portion and a shaft extending axially downwardly from the user input portion. The shaft includes a shoulder defining a downwardly facing contact surface. A hub includes a side wall defining an internal chamber extending between an open upper end and an open lower end. The open upper end includes an upwardly facing contact surface. A lip within the internal chamber of the hub defines a downwardly facing surface. The shaft of the handle is received within the open upper end. A push nut retains the shaft of the handle to the hub. The push nut includes an upper surface and is slidably adjustable along the shaft of the handle for axial positioning relative to the downwardly facing surface of the lip of the hub for accommodating tolerances between the handle and the hub. The upwardly and downwardly facing surfaces of the hub captured between the downwardly facing surface of the shaft of the handle and the upper surface of the push nut.

A valve body includes an upper receiving member configurative to receive a valve cartridge, and a mounting shank extends downwardly from the upper receiving member and includes a retaining lip. A mounting base is recessed within the chamber of the hub. The mounting base includes a support defining a center opening and a coupler extending upwardly from the base and cooperating with an inner surface of the side wall hub to secure the hub to the mounting base. The retaining lip of the mounting shank is supported by an upper surface of the mounting base.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

The detailed description of the drawings particularly refers to the accompanying figures in which:

FIG. 1 is a perspective view of an illustrative faucet handle assembly of the present disclosure coupled to a valve body, with a mounting deck shown in phantom;

FIG. 2 is a top exploded perspective view of the faucet handle assembly and valve body of FIG. 1;

FIG. 3 is a bottom exploded perspective view of the faucet handle assembly and valve body of FIG. 1;

FIG. 4 is an exploded perspective view of the handle hub, valve body and mounting base of FIG. 1;

FIG. 5 is a cross-sectional view taken along line 5-5 of FIG. 1;

FIG. 6 is a cross-sectional view taken along line 6-6 of FIG. 1;

FIG. 7 is a detailed exploded perspective view of the faucet handle blade mounting assembly of FIG. 1;

FIG. 8 is a perspective view of a further illustrative faucet handle assembly of the present disclosure coupled to a valve body, with a mounting deck shown in phantom;

FIG. 9 is a top exploded perspective view of the handle assembly and valve body of FIG. 8;

FIG. 10 is a bottom exploded perspective view of the handle assembly and valve body of FIG. 8;

FIG. 11 is a cross-sectional view taken along line 11-11 of FIG. 8;

FIG. 12 is a partially exploded perspective view of a faucet including an illustrative faucet handle assembly of the present disclosure for coupling with a valve body;

FIG. 13 is a top exploded perspective view of the handle assembly and valve body of FIG. 12;

FIG. 14 is a bottom exploded perspective view of the handle assembly and valve body of FIG. 12; and

FIG. 15 is a cross-sectional view of the handle assembly and valve body of FIG. 12.

### DETAILED DESCRIPTION OF THE DRAWINGS

The embodiments of the invention described herein are not intended to be exhaustive or to limit the invention to precise forms disclosed. Rather, the embodiments elected for description have been chosen to enable one skilled in the art to practice the invention.

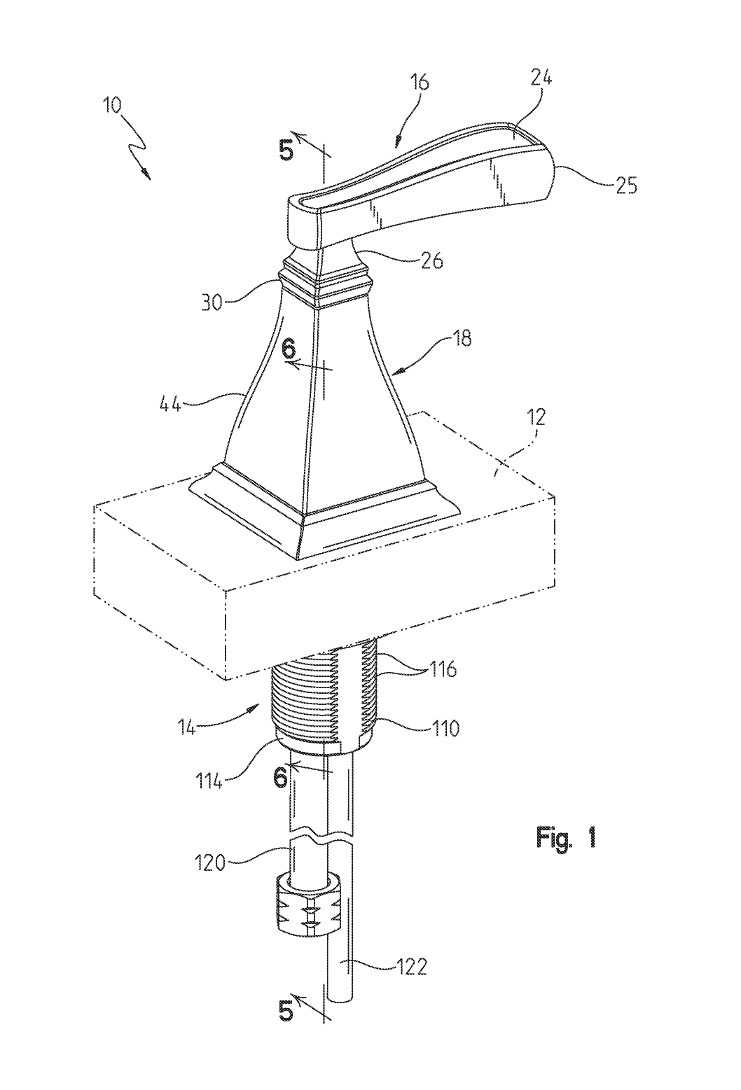

Referring initially to FIGS. 1-3, an illustrative faucet handle assembly 10 is configured to be coupled to a mounting deck 12, such as a sink deck, for controlling water flow through a valve assembly 14. The faucet handle assembly 10 illustratively includes a handle 16 rotatably supported by a hub 18. The handle 16 is operably coupled to a valve cartridge 20 of the valve assembly 14. The hub 18 is secured to a mounting base 22 which, in turn, in secured to the mounting deck 12.

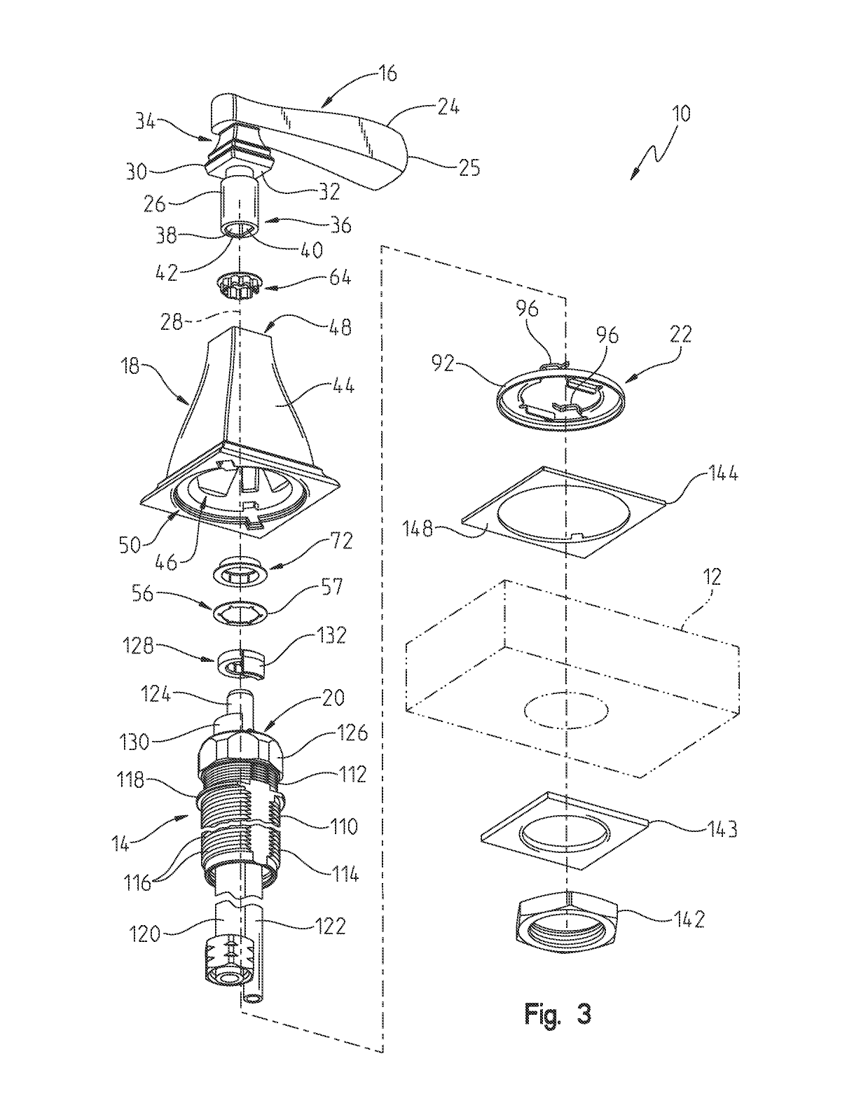

The handle 16 illustratively includes a user input portion 24 and a shaft 26 extending axially downwardly from the user input portion 24. Illustratively, the user input portion 24 comprises a handle blade or lever 25 extending substantially perpendicular to the shaft 26. Alternatively, the user input portion 24 may comprise other user interfaces, such as a knob (not shown). The shaft 26 extends along a longitudinal axis 28 and includes a shoulder 30 defining a downwardly facing surface 32. An upper end 34 of shaft 26 is coupled to user input portion 24, while a lower end 36 of the shaft 26 includes an opening 38. The opening 38 illustratively includes a flat 40 and an arcuate wall 42, together defining a D-shaped cross-section (FIG. 3). In one illustrative embodiment, the handle 16 is integrally formed from a metal, such as a plated zinc alloy.

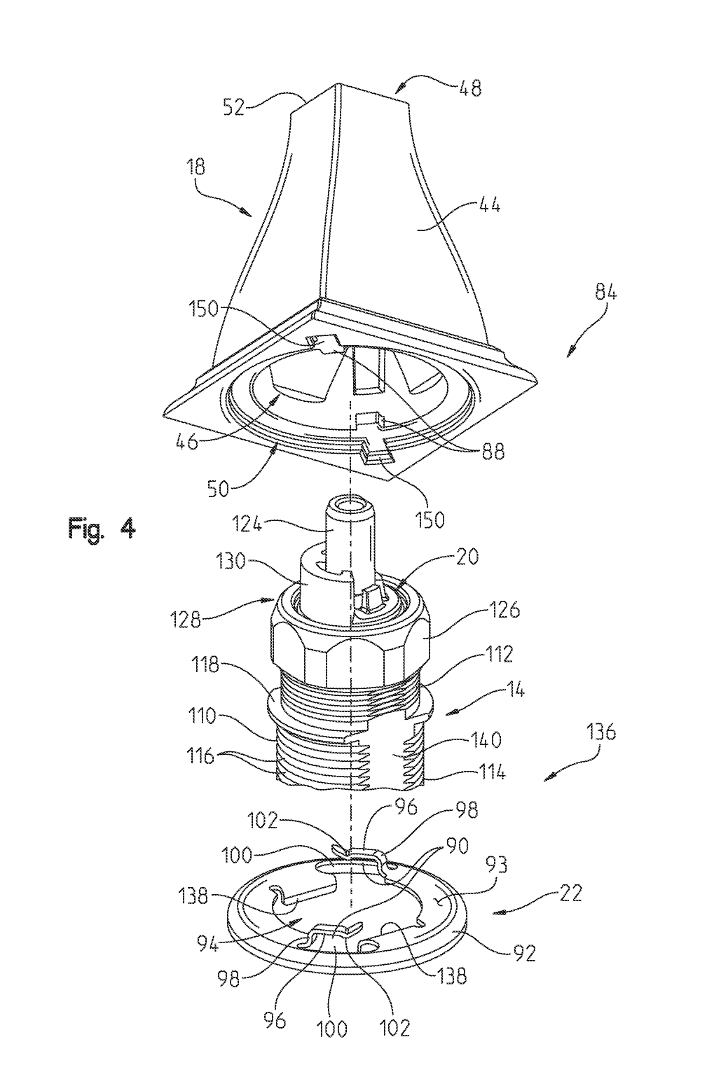

With respect to FIGS. 4-6, the hub 18 includes a side wall 44 defining an internal chamber 46 extending between open upper end 48 and an open lower end 50. In the illustrative embodiment, the side wall 44 is rectangular, and more particularly square, in lateral cross-section. The open upper end 48 includes an upwardly facing surface 52. A lip 53 is formed in the internal chamber 46 and defines a downwardly facing surface 54. An opening 55 extends between surfaces 52 and 54 for receiving shaft 26 of the handle 16. The shaft 26 is illustratively received within the open upper end 48 and axially restrained by an upper coupler 56. In one illustrative embodiment, the hub 18 is integrally formed from a metal, such as a plated zinc alloy.

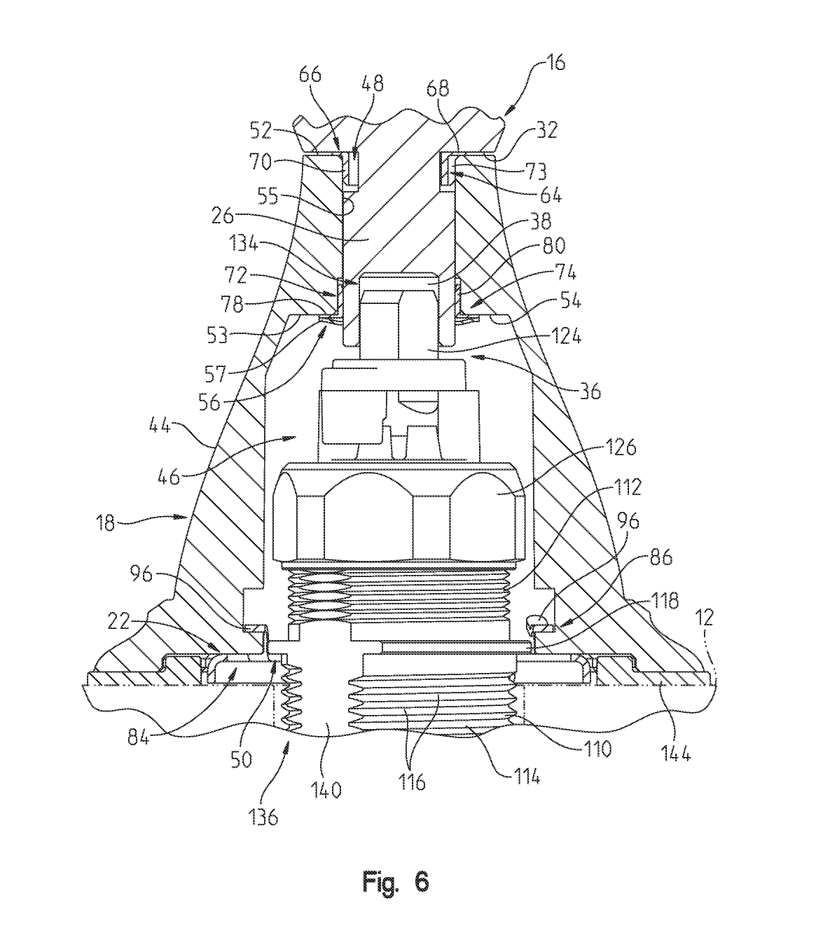

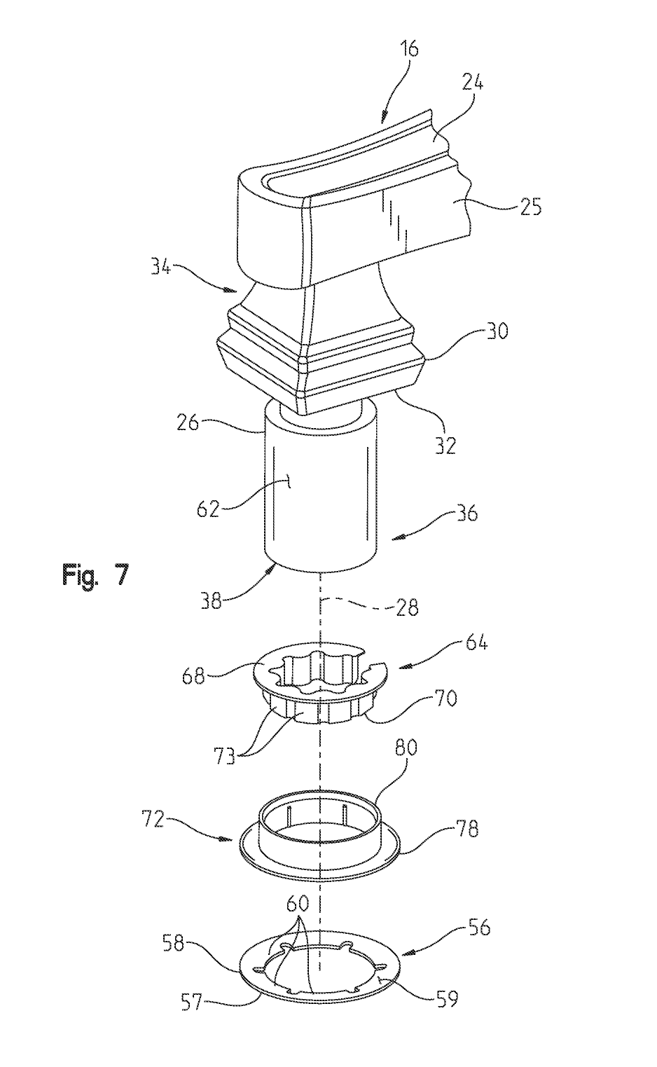

With respect to FIGS. 6 and 7, the upper coupler 56 illustratively includes a push nut 57 concentrically received on the lower end 36 of the shaft 26 to axially restrain the shaft 26 of the handle 16 while permitting rotation of the shaft 26 about longitudinal axis 28. The push nut 57 is slidably adjustable on the shaft 26 of the handle 16 for axial positioning relative to the downwardly facing surface 32 of the shoulder 30 of the handle 16, and the downwardly facing surface 54 of the lip 53 of the hub 18. Axial adjustability of the push nut 57 accommodates dimensional tolerances between the handle 16 and the hub 18. Illustratively, the push nut 57 is a conventional non-threaded fastener including an annular ring 58 having an upper surface 59, and a plurality of radially inwardly extending tangs 60 configured to frictionally engage the outer surface 62 of the handle shaft 26 (FIG. 7). The upwardly and downwardly facing surfaces 52 and 54 of the hub 18 are captured between the downwardly facing surface 32 of the handle shaft 26 and the upper surface 59 of the push nut 57 such that the handle shaft 26 is journaled for rotation within the opening 55 at the upper end of the hub 18.

An upper glide ring 64 is positioned intermediate the shoulder 30 of the handle shaft 26 and the hub 18 to define an upper bearing 66 between the upwardly facing surface 52 of the hub 18 and the downwardly facing surface 32 of the handle 16. The glide ring 64 illustratively comprises a split friction ring including an upper flange 68 and a downwardly extending cylindrical wall 70. The wall 70 includes a plurality of radially outwardly extending ribs 73 configured to frictionally engage the opening 55 at the upper end 48 of the hub 18. The upper glide ring 64 is illustratively formed of a polymer, such as a polypropylene. A lower glide ring 72 is positioned intermediate the hub 18 and the push nut 57 to define a lower bearing 74 between the downwardly facing surface 54 of the hub 18 and the upper surface 59 of the push nut 57. The lower glide ring 72 illustratively includes a lower flange 78 and an upwardly extending cylindrical wall 80. The lower glide ring 72 is illustratively formed of a polymer, such as polyoxymethylene.

A lower coupler 84 includes a hub orientation device 86 and is configured to secure the hub 18 with the mounting base 22. The square cross-section of the hub 18 requires proper orientation relative to the mounting base 22 to provide proper aesthetics of the handle assembly 10 when coupled to the mounting deck 12. In the illustrative embodiment of FIG. 1-3, the lower coupler 84 is recessed within the internal chamber 46 of the hub 18. As shown in FIG. 4, the lower coupler 84 illustratively includes opposing retainer tabs 88 extending inwardly from the side wall 44 of the hub 18 and configured to cooperate with opposing rotational lock channels 90 defined by the mounting base 22.

With respect to FIG. 4, the mounting base 22 illustratively includes a support 92 having an upper surface 93 and defining a central opening 94 and opposing arms 96 positioned outwardly from the central opening 94 and defining rotational lock channels 90 to receive the retainer tabs 88 of the hub 18. Each arm 96 includes a first end having a connector 98 secured to the support 92, and a freely supported second end defining an opening 100. A detent 102, illustratively a bend formed within the arm 96, is positioned proximate the opening 100 at the second end of arm 96. The tabs 88 cooperated with the detents 102 to define a locked position. The hub is in an unlocked position when the tabs 88 are positioned outside of the channels 90. As the hub 18 is rotated clockwise by approximately 90 degrees, it is moved into a locked position such that the tabs 88 are received within the lock channels 90. As tabs 88 are positioned intermediate the detents 102 and the first end connector 98, the hub 18 is properly oriented relative to the mounting base 22. As such, the side wall 44 of the hub 18 is rotationally oriented on the mounting deck 12.

In one illustrative embodiment, the mounting base 22 is formed of a stamped metal, such as stainless steel. In alternative embodiments, the mounting base 22 may be formed of other materials, such as a molded polymer. If a polymer is used for the mounting base 22, the arms 96 may be connected to the support 92 at opposing ends (similar to connector 98) to provide additional structural support.

The valve assembly 14 includes a valve body 110 having an upper receiving member 112 configured to receive the valve cartridge 20. A mounting shank 114 extends downwardly from the upper receiving member 112 and includes external threads 116 and a retaining lip 118. The retaining lip 118 is supported by an upper surface 93 of the mounting base 22. More particularly, the mounting shank 114 of valve body 110 may pass through central opening 94 and then stopped by retaining lip 118. The valve body 110 may be formed of a metal, such as brass.

Water conduits, illustratively water inlet tube 120 and water outlet tube 122, extend upwardly into the mounting shank 114 and are in fluid communication with the valve cartridge 20. The valve cartridge 20 may be of conventional design as including a valve member (not shown) driven in rotation by a valve stem 124 to control the flow of water from the inlet tube 120 to the outlet tube 122. More particularly, the handle 16 rotates the valve stem 124 to cause simultaneous rotation of the valve member. The valve stem 124 is illustratively D-shaped in lateral cross-section.

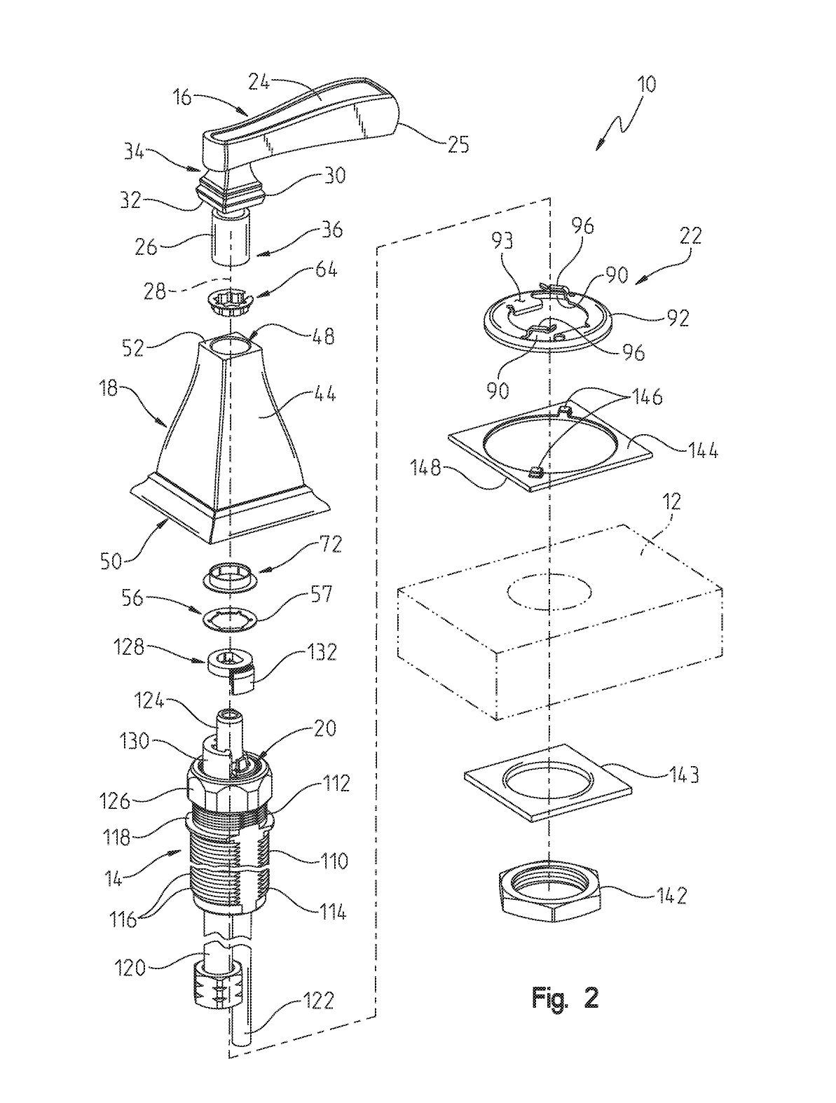

A bonnet nut 126 threadably engages the valve body 110 and secures the valve cartridge 20 within the receiving member 112. A rotational limit stop 128 limits rotation of the valve stem, illustratively to approximately 90 degrees (i.e., quarter turn). The limit stop 128 illustratively includes a first or stationary member 130 secured in position by the bonnet nut 126, and second or rotatable member 132 coupled to the valve stem 124 (FIGS. 2-4).

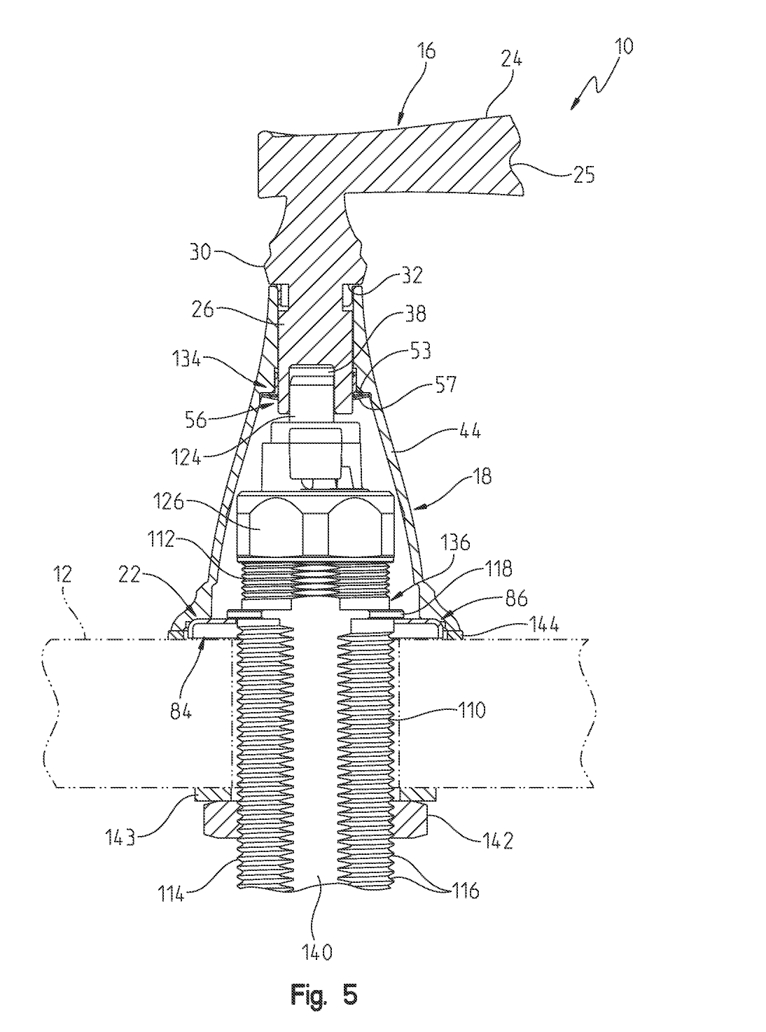

With respect to FIGS. 5 and 6, a handle orientation device 134 angularly orients the user input portion 24 of the handle 16 relative to the valve stem 124. The user input portion 24 of the handle 16 needs to be properly located relative to the valve stem 124 to correlate positioning of the handle 16 relative to desired water flow. More particularly, the handle orientation device 134 includes the D-shaped lower opening 38 of the shaft 26 cooperating with the D-shaped valve stem 124.

A valve body orientation device 136 angularly orients the valve body 110, and hence the valve cartridge 20, relative to the mounting base 22. The valve body orientation device 136 illustratively includes first orientation flats 138 supported by the mounting base 22 which cooperate with second orientation flats 140 supported by the mounting shank 114. Cooperation or alignment between the first and second orientation flats 138 and 140 angularly orients the valve body 110 to the mounting base 22. A mounting nut 142 engages the external threads 116 of the mounting shank 114 to secure the valve body 110 to a mounting deck 12. More particularly, the mounting deck 12 and the mounting base 22 are clamped between the retaining lip 118 of the valve body 110 and the mounting nut 142. A washer 143 may be positioned between the mounting nut 142 and a lower surface of the mounting deck 12.

A gasket 144 is positioned axially intermediate the hub 18 and the mounting base 22, and extends radially around the outside of the mounting base 22. The gasket 144 is illustratively formed of a polymer and is configured to resist possible corrosion between the zinc of the hub 18 and the mounting deck 12. The gasket 144 includes locating tabs 146 extending upwardly from a base 148 and configured to be received within corresponding recesses 150 formed in the bottom of the hub 18 (FIG. 4).

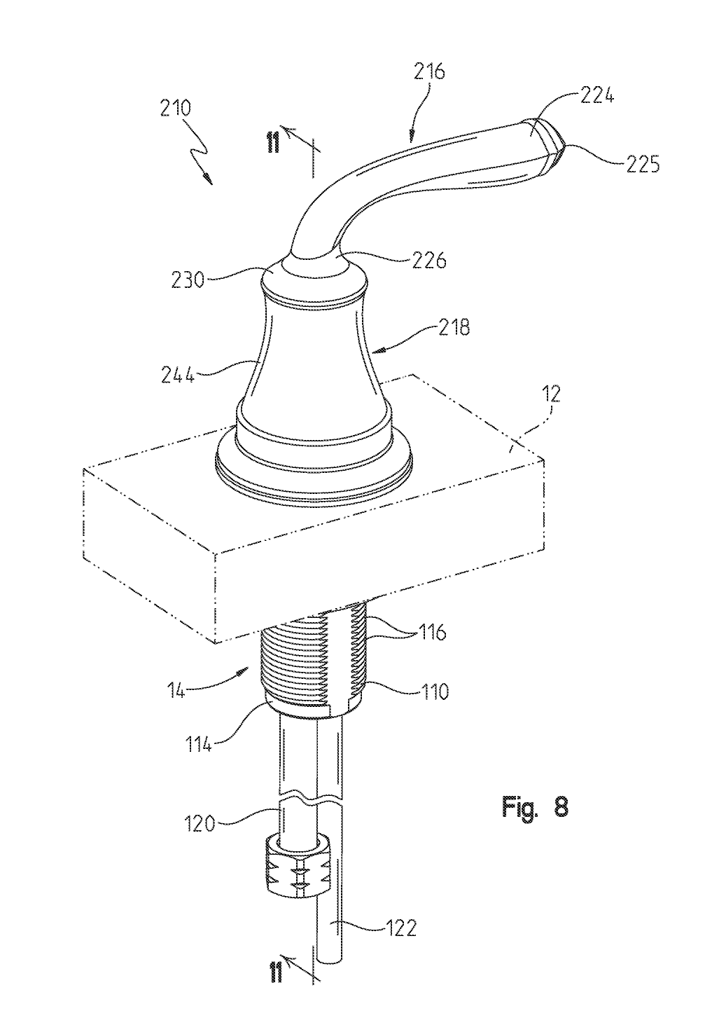

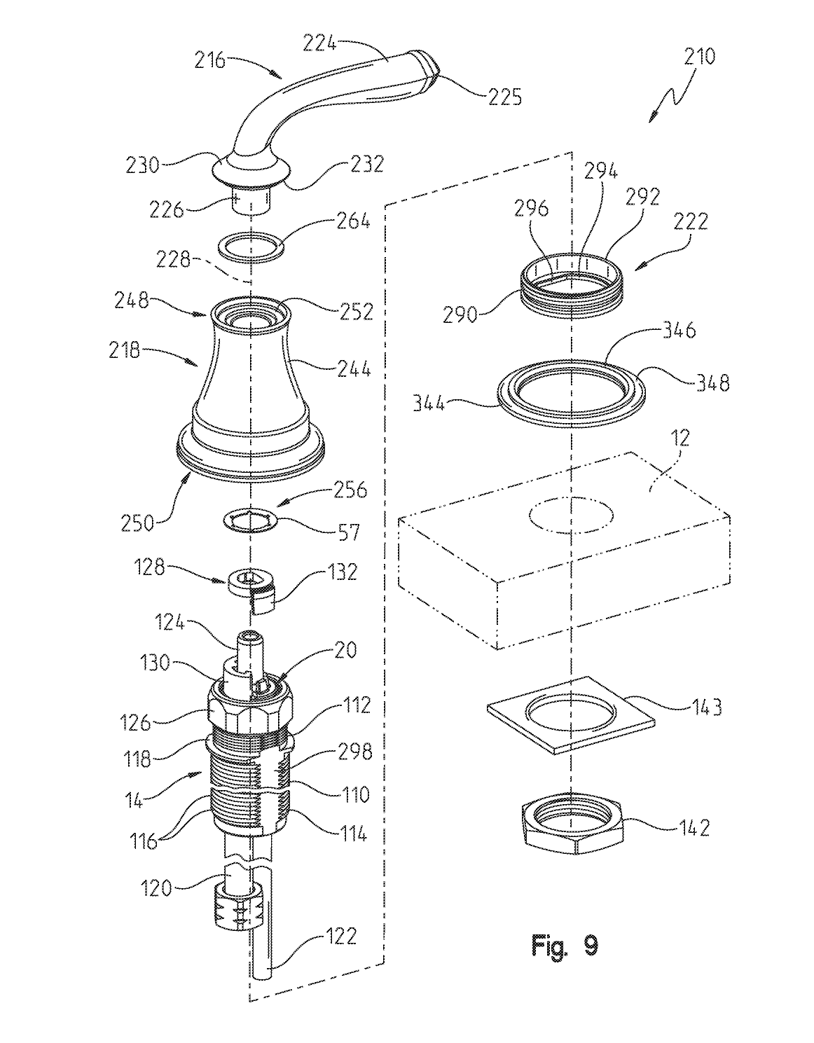

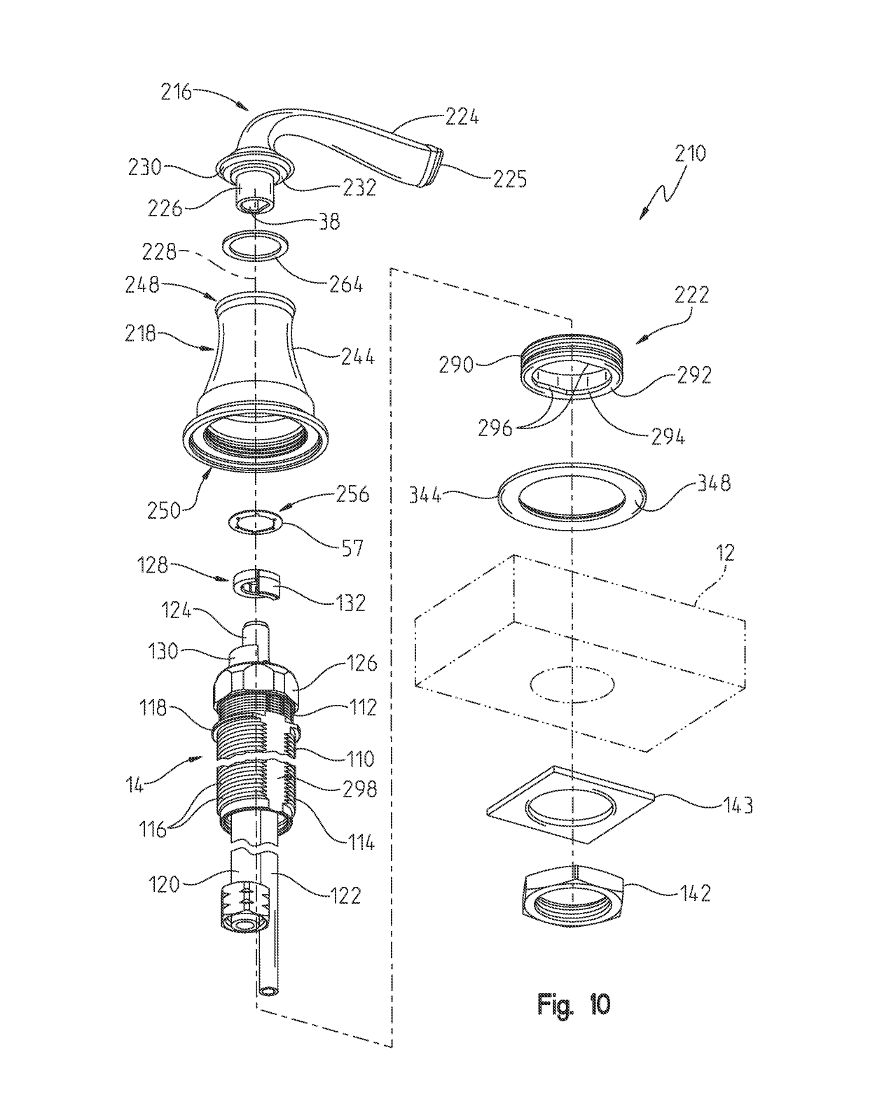

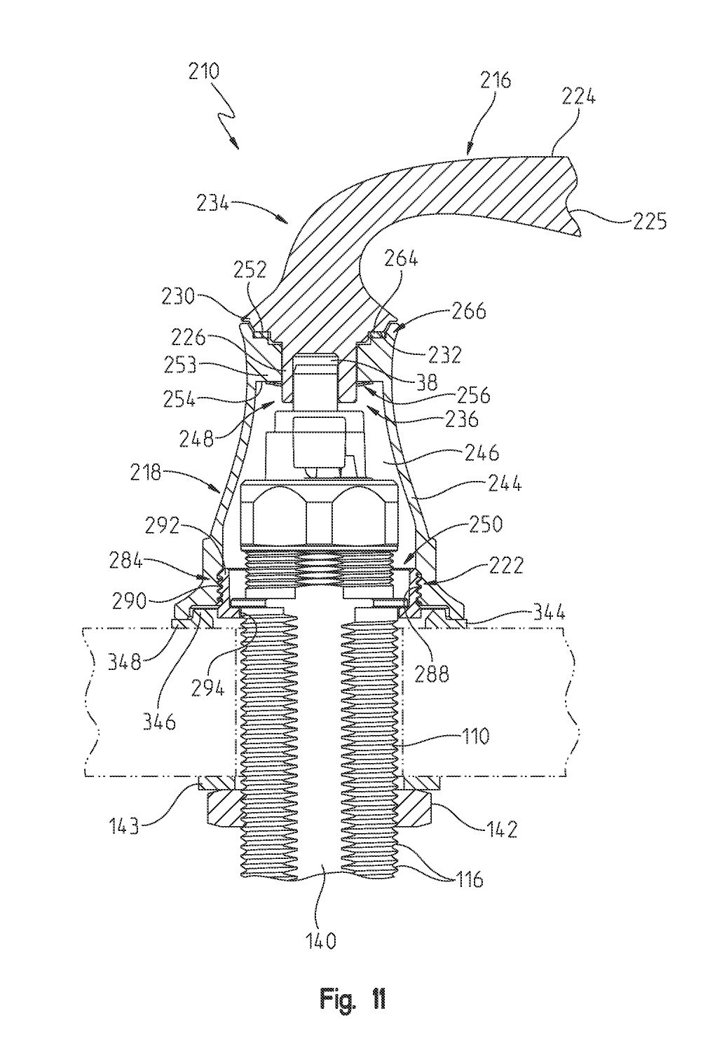

With reference now to FIGS. 8-11, a further illustrative embodiment faucet handle assembly 210 is shown. Faucet handle assembly 210 includes many elements similar to faucet handle assembly 10. As such, similar components will be identified in the following description with like reference numbers.

The faucet handle assembly 210 includes a handle 216 illustratively including a user input portion 224 and a shaft 226 extending axially downwardly from the user input portion 224. Illustratively, the user input portion 224 comprises a handle blade or lever 225. Alternatively, the user input portion 224 may comprise a knob (not shown). The shaft 226 extends along a longitudinal axis 228 and includes a shoulder 230 defining a downwardly facing surface 232. An upper end 234 of shaft 226 is coupled to user input portion 224, while a lower end 236 of the shaft 226 includes D-shaped opening 38. In one illustrative embodiment, the handle 216 is integrally formed from a metal, such as a plated zinc alloy.

A hub 218 includes a side wall 244 defining an internal chamber 246 extending between open upper end 248 and an open lower end 250. In the illustrative embodiment, the side wall 244 is arcuate, and more particularly circular, in lateral cross-section. The open upper end 248 includes an upwardly facing surface 252. A lip 253 is formed in the internal chamber 246 and defines a downwardly facing surface 254. An opening 255 extends between surfaces 252 and 254 for receiving shaft 226 of the handle 216. The shaft 226 is illustratively received within the open upper end 248 and axially restrained by an upper coupler 256. In one illustrative embodiment, the hub 218 is integrally formed from a metal, such as a plated zinc alloy.

The upper coupler 256 of faucet handle assembly 210 illustratively includes push nut 57 as detailed above. More particularly, the push nut 57 is concentrically received on the lower end 236 of the shaft 226 to axially restrain the shaft 226 of the handle 216 while permitting rotation of the shaft 226 about longitudinal axis 228.

A glide ring 264 is illustratively positioned between the shoulder 230 of the handle 216 and the hub 218 to define an upper bearing 266 between upwardly facing surface 252 of the hub 218 and the downwardly facing surface 232 of the handle 216. The glide ring 264 is illustratively formed of a polymer, such as nylon.

A lower coupler 284 of faucet handle assembly 210 illustratively includes a mounting base 222 including a side wall 292 supporting external threads 290. The external threads 290 are configured to threadably couple with internal threads 288 supported by the side wall 214 of the hub 218. The mounting base 222 is recessed within the internal chamber 246 of the hub 218. Similar to the hub 218, the mounting base 222 may be formed of a metal, such as a zinc alloy.

The mounting base 222 further includes an inwardly extending base or lower flange 294 configured to key with the valve body 110. More particularly, flats 296 formed in the lower flange 294 cooperate with flats 298 formed in the mounting shank 114 to rotationally orient and secure the mounting base 222 relative to the valve body 110, thereby defining a valve body orientation device.

A gasket 344 is positioned axially intermediate the hub 218 and the mounting base 222, and extends radially around the mounting base 222. The gasket 344 is illustratively formed of a polymer and is configured to resist possible corrosion between the zinc of the hub 218 and the mounting deck 12. The gasket 344 includes a locating flange 346 extending upwardly from a base 348.

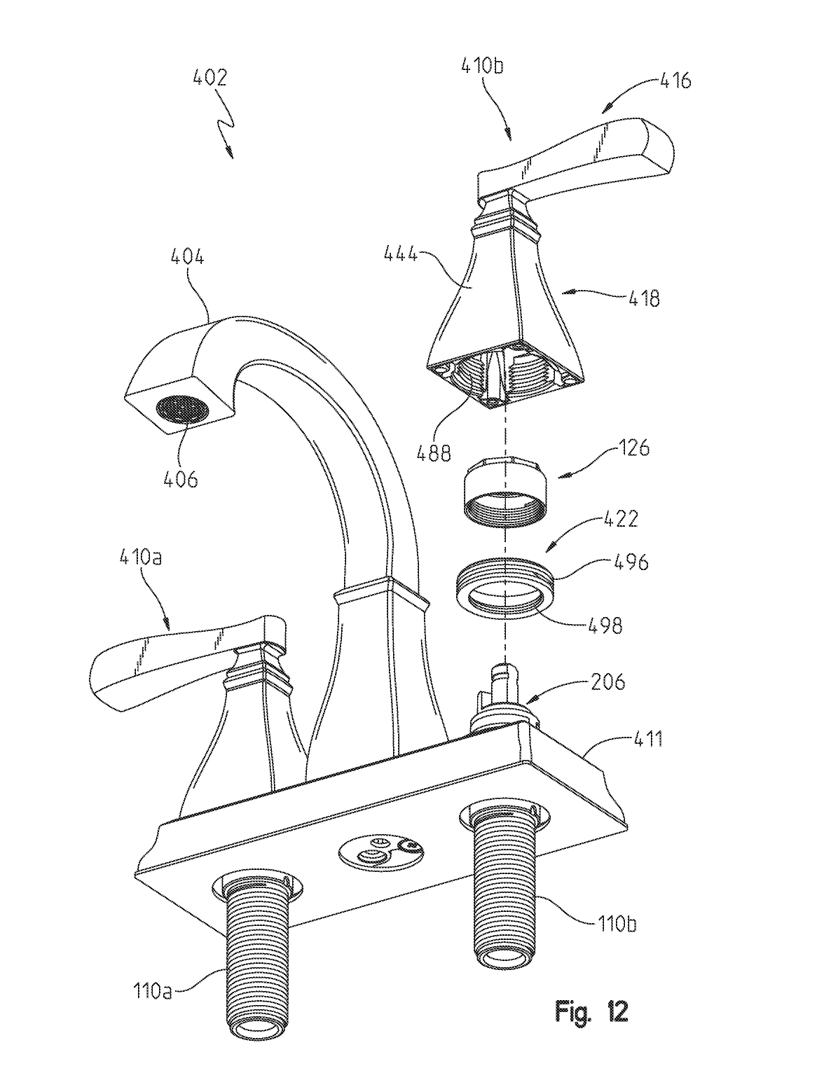

With reference now to FIGS. 12-15, a further illustrative embodiment faucet handle assembly 410 is shown for use with faucet 402. Faucet 402 includes a pair of illustrative faucet handle assemblies 410a and 410b positioned on opposite sides of a delivery spout 404 including a fluid outlet 406. The faucet handle assemblies 410a and 410b are configured to control water flow through hot and cold water valve cartridges 20a and 20b, respectively, to the fluid outlet 406. Each faucet handle assembly 410 includes many elements similar to faucet handle assembly 210, as further detailed above. As such, similar components will be identified in the following description with like reference numbers.

Bonnet nut 126 threadably engages each valve body 110 and secures the valve cartridge 20 within receiving member 112. An escutcheon 411 is positioned below the handle assemblies 410 and delivery spout 404, and above a mounting deck 412.

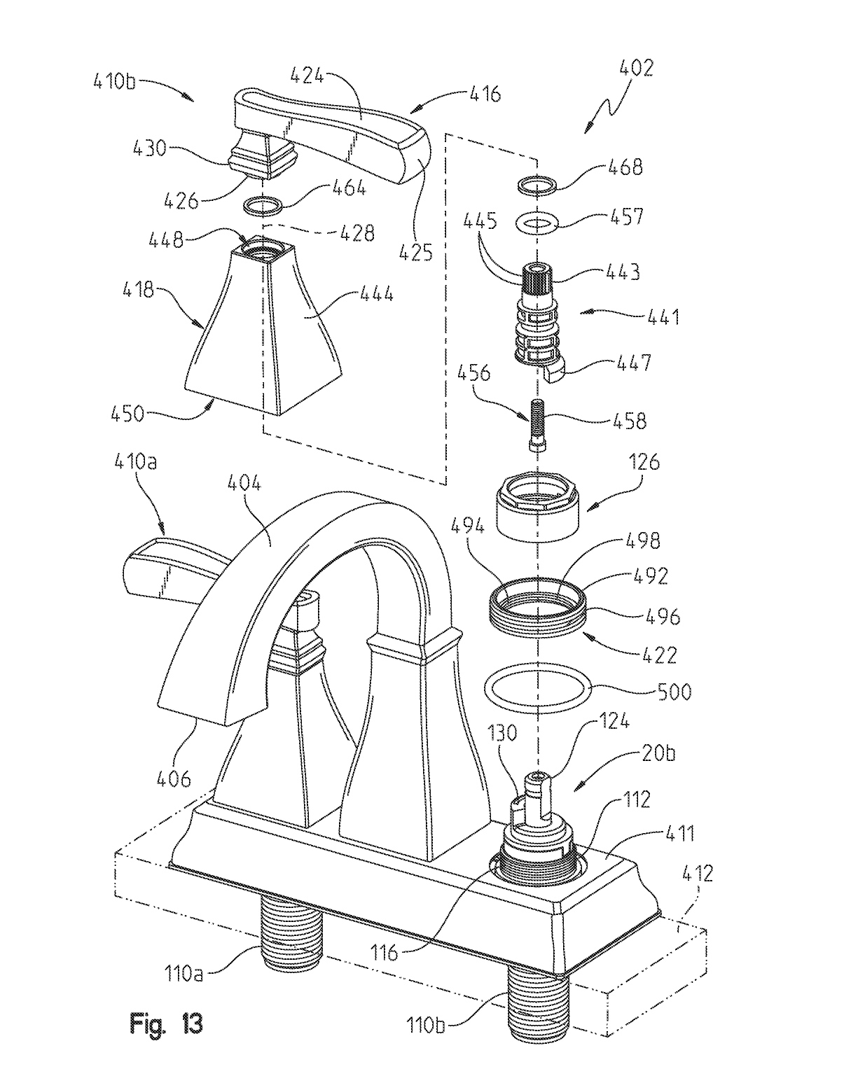

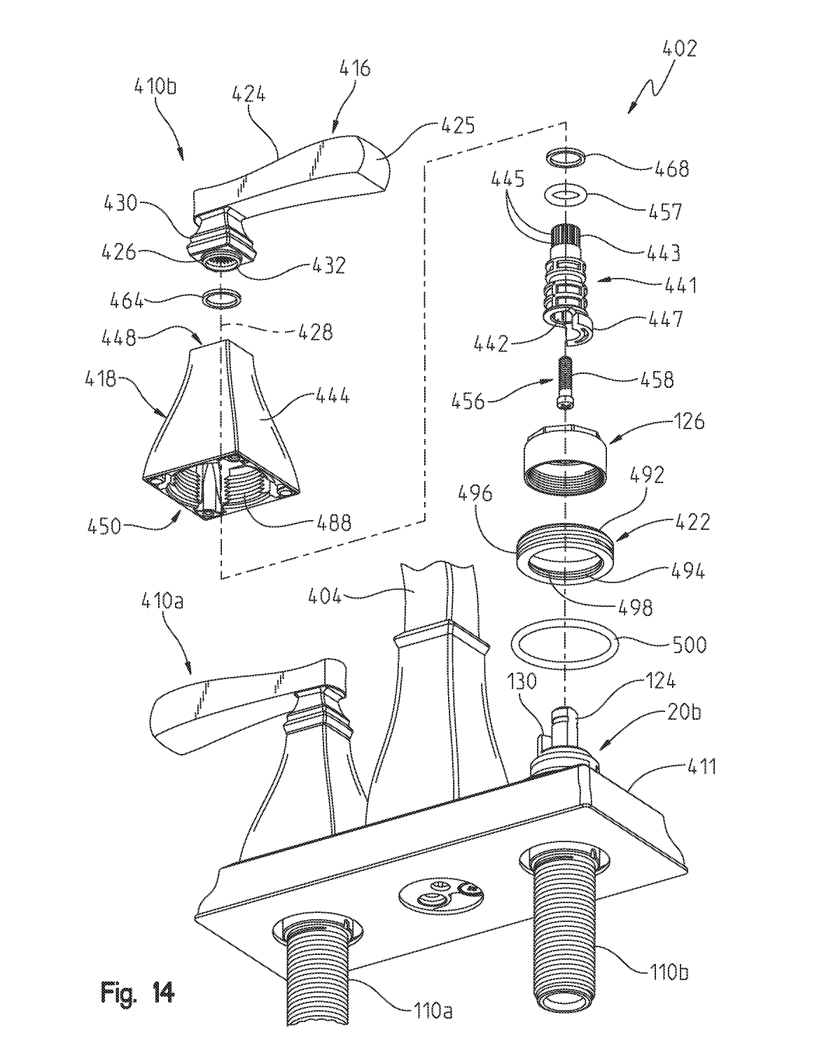

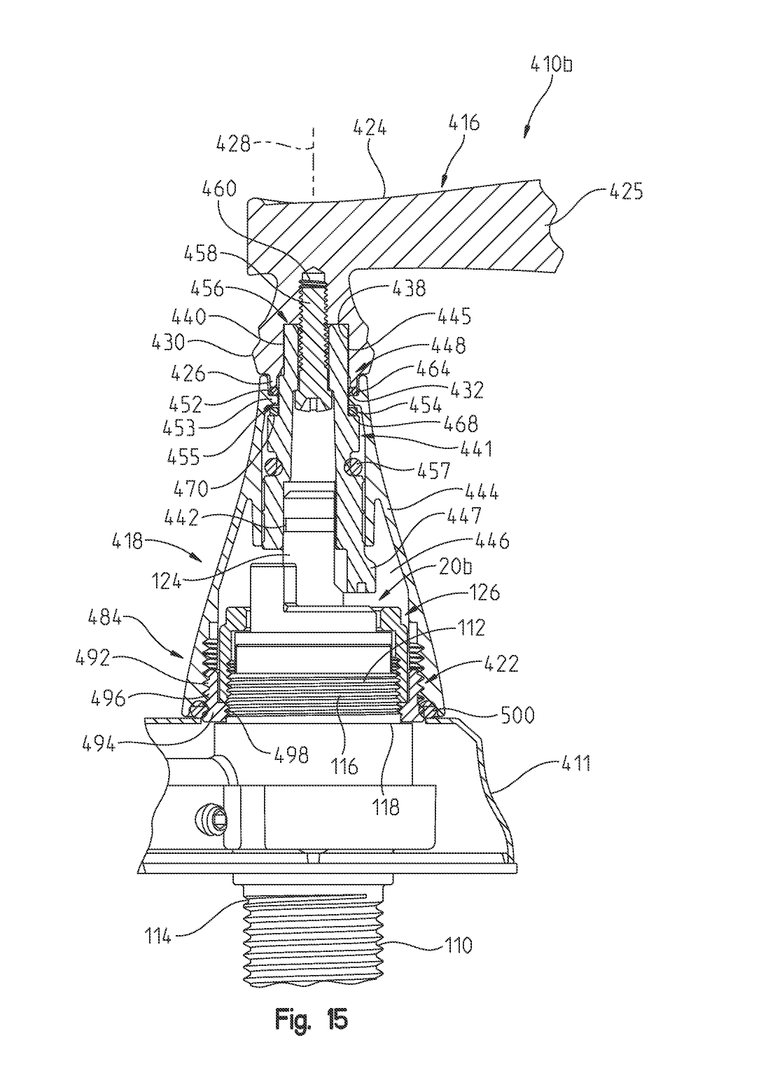

Referring now to FIGS. 13-15, each faucet handle assembly 410 includes a handle 416 illustratively having a user input portion 424 and a base or shaft 426 extending downwardly from the user input portion 424. Illustratively, the user input portion 424 comprises a handle blade or lever 425. Alternatively, the user input portion 424 may comprise of knob (not shown). The shaft 426 extends along a longitudinal axis 428 and includes a shoulder 430 and a downwardly facing surface 432. An upper end of shaft 426 is coupled to user input portion 424, while a lower end of shaft 426 includes an opening 438 having a plurality of splines 440 (FIGS. 14 and 15). In one illustrative embodiment, the handle 416 is integrally formed from a metal, such as a plated zinc alloy.

A stem extension or carrier 441 extends along longitudinal axis 428 and rotatably couples the handle 416 with the valve stem 124 of the valve cartridge 20. The carrier 441 may be formed of a polymer and illustratively includes a lower opening 442 have a D-shaped cross-section to receive D-shaped valve stem 124. The carrier 441 further includes an upper shaft 443 including a plurality of splines 445. The upper shaft 443 is received within the opening 438 of the handle 416, wherein the splines 445 cooperate with the splines 440 to prevent relative rotation between the handle 416 and the carrier 441. A rotational limit stop limits rotation of the valve stem 124, illustratively to approximately 90 degrees (i.e., quarter turn). The limit stop illustratively includes first or stationary member 130 secured in position by the bonnet nut 126, and second or rotatable member 447 supported by the carrier 441 and thereby coupled to the valve stem 124.

A hub 418 includes a sidewall 444 defining an internal chamber 446 extending between an open upper end 448 and an open lower end 450. In the illustrative embodiment, the sidewall 444 is rectangular, and more particularly square, in lateral cross-section. A lip 453 is formed in the internal chamber 446 proximate the open upper end 448, and defines an upwardly facing surface 452 and a downwardly facing surface 454. An opening 455 extends between surfaces 452 and 454 for receiving the carrier 441. The carrier 441 is illustratively received within the open upper end 448 and is axially restrained by an upper coupler 456.

The upper coupler 456 of faucet handle assembly 410 illustratively includes a threaded bolt 458 received within a threaded opening 460 of the handle 416 to couple the carrier 441 with the shaft 426 of the handle 416. The assembled handle 416 and carrier 441 are axially retained by lip 453 of hub 418. In one illustrative embodiment, the hub 418 is integrally formed from a metal, such as a plated zinc alloy. An o-ring 457 may be positioned between the carrier 441 and the hub 418 to prevent undesired lateral movement or wobble.

An upper glide ring 464 is illustratively positioned between the downwardly facing surface 432 of the handle 416 and the lip 453 of the hub 418 to define an upper bearing between upwardly facing surface 452 of the hub 418 and the downwardly facing surface 432 of the handle 416. A lower glide ring 468 is illustratively positioned between the lip 453 of the hub 418 and an upwardly facing surface 470 of the carrier 441 to define a lower bearing between downwardly facing surface 454 of the hub 418 and the carrier 441. The glide rings 464 and 468 are illustratively formed of a polymer, such as nylon.

A lower coupler 484 of the faucet handle assembly 410 illustratively includes a mounting base or adapter 422 including a sidewall 492 and an inwardly extending lower base or flange 494. The sidewall 492 includes radially outwardly extending external threads 496, while the flange 494 includes radially inwardly extending internal threads 498. The external threads 496 are configured to threadably couple with internal threads 488 supported by the sidewall 414 of the hub 418. The internal threads 498 are configured to threadably couple with the threads 116 of the mounting shank 114. In the illustrative embodiment, both the bonnet nut 126 and the mounting base 422 threadably engage the same set of threads 116 on the mounting shank 114.

With further reference to FIG. 15, the mounting base 422 is recessed within the internal chamber 446 of the hub 418. The lower end of the bonnet nut 126 illustratively telescopes within the mounting base 422. More particularly, the lower end of the bonnet nut 126 is laterally positioned between the sidewall 492 of the mounting base 422 and valve body 110, and is longitudinally positioned above the flange 494 of the mounting base 422. Similar to the hub 418, the mounting base 422 may be formed of a metal, such as a zinc alloy. A seal, such as an o-ring 500, may be positioned intermediate the hub 418 and the escutcheon 411.

During assembly, it may be appreciated that the internal threads 498 of the mounting base 422 are threaded onto the threads 116 of the valve body 110, illustratively until bottoming out on the lip 118. Next, the bonnet nut 126 is threaded onto the threads 116 of the valve body 110 to capture the valve cartridge 20 therein. The internal threads 488 of the hub 418 may then be threaded onto the external threads 496 of the mounting base 422. As such, the mounting base 422 allows the hub 418 to be coupled and uncoupled from the valve body 110 independent from the bonnet nut 126.

Although the invention has been described in detail with reference to certain preferred embodiments, variations and modifications exist within the spirit and scope of the invention as described and defined in the following claims.

1. A faucet handle assembly comprising:
a hub including a side wall defining an internal chamber extending upwardly from an open lower end and supporting internal threads;
a valve body including an upper receiving member configured to receive a valve cartridge having a valve stem and having external threads;
a mounting base received within the internal chamber of the hub, the mounting base including a cylindrical side wall, a plurality of external threads, and a plurality of internal threads; and
wherein the external threads of the mounting base threadably couple with the internal threads of the hub, and the internal threads of the mounting base threadably couple with the external threads of the valve body.

2. The faucet handle assembly of claim 1, further comprising a bonnet nut threadably coupled to the valve body, and positioned within the hub.

3. The faucet handle assembly of claim 2, wherein the mounting base further includes a flange extending laterally from the side wall between the valve body and the bonnet nut.

4. The faucet handle assembly of claim 1, further comprising a handle including a user input portion and a shaft extending axially downwardly from the user input portion, the shaft of the handle being received within an open upper end of the hub.

5. The faucet handle assembly of claim 4, further comprising a carrier extending within the internal chamber of the hub between the valve stem of the valve cartridge and the shaft of the handle.

6. The faucet handle assembly of claim 5, wherein the hub includes an inwardly extending lip axially retaining the handle with the hub when the handle is coupled to the carrier.

7. The faucet handle assembly of claim 6, wherein a fastener couples the shaft of the handle with the carrier.

8. The faucet handle assembly of claim 6, further comprising an upper glide ring positioned intermediate the shaft of the handle and the lip of the hub, and a lower glide ring positioned intermediate the lip of the hub and the carrier.

9. The faucet handle assembly of claim 2, wherein a lower end of the bonnet nut is positioned between the side wall of the mounting base and the valve body.

10. The faucet handle assembly of claim 9, wherein the bonnet nut and the mounting base threadably engage the same set of threads on the valve body.

11. The faucet handle assembly of claim 1, wherein the valve body further includes a mounting shank extending downwardly from the upper receiving member.

12. A faucet handle assembly comprising:
a hub including a side wall defining an internal chamber extending upwardly from an open lower end and supporting internal threads;
a valve body including an upper receiving member configured to receive a valve cartridge and extending within the internal chamber of the hub;
a mounting base extending within the internal chamber of the hub, the mounting base including a plurality of external threads and a plurality of internal threads; and
wherein the external threads of the mounting base are operably coupled with the hub, and the internal threads of the mounting base are operably coupled with the valve body.
